(19) United States
(12) Patent Application Publication
(10) Pub. No.: US 2021/0125208 A1
(43) Pub. Date: Apr. 29, 2021

(54) DIRECT, ONLINE MARKETING SYSTEM FOR MERCHANTS

(71) Applicants: Michael Spinka, Springfield, PA (US); Paul E. Berman, Thornton, PA (US); Brian Smith, Concord, NC (US)

(72) Inventors: Michael Spinka, Springfield, PA (US); Paul E. Berman, Thornton, PA (US); Brian Smith, Concord, NC (US)

(21) Appl. No.: 16/664,859

(22) Filed: Oct. 27, 2019

(51) Int. Cl. G06Q 30/02; G06Q 50/00; G06Q 10/10; G06F 7/08; G06F 16/245; G06N 20/00; G06F 16/29

(52) U.S. Cl. CPC G06Q 30/0205; G06Q 30/0235; G06Q 30/0239; G06Q 30/0224; G06Q 50/01; G06Q 10/10; G06F 3/0482; G06F 7/08; G06F 16/245; G06N 20/00; G06F 16/29; G06Q 30/0211; G06Q 30/0236

(57) ABSTRACT

A method for utilizing a direct, online marketing system. A database is provided that stores information usable by a merchant, the database having at least one type of information selected from a group consisting of: personal, demographic, and geographical information relating to present and potential members of goods and services provided by the merchant. Redeemable, one-time gifts are sent directly to the present and potential customers at predetermined times dependent upon the information stored in the database.

### FIELD OF THE INVENTION

The present invention relates to marketing systems and, more particularly, to a direct, online marketing system that uses a database having personal, demographic, and geographical information relating to present and potential customers of goods and services provided by a merchant.

### BACKGROUND OF THE INVENTION

Paper coupons have been used, conventionally, to encourage customers to visit retail establishments, such as restaurants, theaters, service stations, etc. Sellers often provide coupons as an incentive to promote sales of specific products or services. These coupons have been delivered through the mail or have been printed or inserted in magazines and newspapers. The basic delivery mechanisms for traditional coupons have changed little over the years even as new technologies have altered the way the typical consumer receives purchase information and makes purchase decisions.

The Internet has driven the development of new methods of delivering information to consumers and has provided marketers additional avenues for delivering promotional information, such as electronic mail. Thus, coupon delivery has moved online. Some manufacturers have included coupons on their web site. These coupons can be downloaded and printed by customers to be redeemed in traditional neighborhood stores.

The ease and relatively low cost of distributing electronic promotional information has led to a dramatic increase in the amount of promotional information received by the average consumer. Most promotional information, however, is untargeted and generally ignored by the recipient.

What is needed is a system that connects businesses with consumers through tasteful gifting and using referrals to friends and family as well as social media to multiply the members that are registered with the inventive system.

### DESCRIPTION OF RELATED ART

U.S. Pat. No. 9,684,909 issued to Baker, et al. for SYSTEMS AND METHODS FOR PROVIDING LOCATION BASED COUPON-LESS OFFERS TO REGISTERED CARD MEMBERS on Jun. 20, 2017, describes a system that provides location based coupon-less offers based upon a location of a card member (CM). A location of a CM may be determined based upon one or more of a travel itinerary, a GPS signal, a proximity of a mobile communication device to a cellular base station, and/or a zip code. An offer from a merchant registered to provide coupon-less offers may be transmitted to a mobile communication device based upon the location. An offer, once accepted by a CM, may be matched to a record of charge associated with a transaction account held by the CM. A credit may be applied to the CM's transaction account and a debit may be applied to a transaction account of the registered merchant. One or more offer categories and/or one or more offer category classes may be transmitted to the mobile communication device based upon the CM's location.

U.S. Pat. No. 9,430,773 issued to Aloni, et al. for LOYALTY INCENTIVE PROGRAM USING TRANSACTION CARDS on Aug. 30, 2016, describes a system and method that provide rewards or loyalty incentives to card member customers. The system includes an enrolled card member customer database, an enrolled merchant database, a participating merchant offer database and a registered card processor. The enrolled card member customer database includes transaction accounts of card member customers enrolled in a loyalty incentive program. The enrolled merchant database includes a list of merchants participating in the loyalty incentive program. The participating merchant offer database includes loyalty incentive offers from participating merchants. The registered card processor receives a record for charge for a purchase made with an enrolled merchant by an enrolled card member customer and uses the record of charge to determine whether the purchase qualifies for a rebate credit in accordance with a discount offer from the enrolled merchant. If the purchase qualifies for a rebate credit, the registered card processor provides the rebate credit to an account of the enrolled card member customer. The system provides a coupon-less way for merchants to provide incentive discounts to enrolled customers.

U.S. Pat. No. 8,606,630 issued to Fordyce, III, et al. for SYSTEMS AND METHODS TO DELIVER TARGETED ADVERTISEMENTS TO AUDIENCE on Dec. 10, 2013, describes a system that includes a transaction handler to process transactions, a data warehouse to store transaction data recording the transactions processed at the transaction handler, a profile generator to generate a profile of a user based on the transaction data, an advertisement selector to identify an advertisement based on the profile of the user in response to the transaction handler processing a transaction of the user, and a portal coupled to the transaction handler to provide the advertisement for presentation to the user in connection with information about the transaction of the user. In one example, the profile includes a plurality of values representing aggregated spending of the user in various areas to summarize the transactions of the user.

U.S. Pat. No. 8,543,470 issued to Grady, et al. for SYSTEM AND METHOD FOR TARGETING LIMITED-TIME OFFER BASED ON LIKELIHOOD OF ACCEPTANCE AND SELECTING TRANSMISSION MEDIA BASED ON CUSTOMER INTEREST on Sep. 24, 2013, describes a system and method for availability based on limited-time offerings and transactions. One embodiment of the present invention provides a system and method that, based on a set of known preferences and historic transactions with customers, culls from a customer database those customers most likely to close a transaction in a short time. The selected customers are notified of the offer, and the system processes the customers responses in a timely manner, and thus allow fleeting inventories to be sold off before they expire.

U.S. Pat. No. 8,504,423 issued to Rotbard, et al. for SOCIAL NETWORK APPRECIATION PLATFORM on Aug. 6, 2013, describes a social network appreciation platform (SNAP) for marketing products or services of a merchant to customers online. A server receives marketing campaigns, announcements, or other messages defined by a participating merchant, for distribution to certain social networks to which a customer of the merchant belongs. The server also receives registration information from the customer including a unique identifier for use in purchase transactions, a selection of the customer's social networks to which certain of the merchant-defined messages are to be distributed, and a selection of the messages for distribution to the selected social networks. In response to transaction data from a transaction source representing a customer purchase, including the customer's unique identifier, the server transmits the messages selected by the customer to each social network selected by the customer, for display on the customer's page and viewing by friends or followers of the customer on the network.

U.S. Pat. No. 8,494,901 issued to Magadi, et al. for METHODS AND SYSTEMS FOR MULTI-MERCHANT COUPONING on Jul. 23, 2013, describes methods and systems for enabling multi-merchant coupon campaigns within an online publication system. In an example, a method can include generating an item listing, receiving information specifying a set of coupon criteria, detecting an event within a multi-merchant publication system, and present a coupon in response to detecting the event. The generating an item listing can be based on information received from a merchant-computer. If the set of coupon criteria is detected it can result in presenting a coupon for the item listing. The event can satisfy particular coupon criteria from the set of coupon criteria.

U.S. Pat. No. 8,468,053 issued to Bennett, et al. for SELLER SELECTION OF CONTENT FOR PROMOTION CREATION on Jun. 18, 2013, describes an online sales/automatic rebate and coupon redemption system that provides online customers automatic retrieval and redemption of all applicable rebates and coupons during purchase. Purchase orders from customers are selectively fulfilled and products are shipped to the customers either by the system for online sales with automatic rebate and coupon redemption or by other merchant or manufacturer environments. The system purchases from merchants using applicable coupons and rebates and then sells the products to the customers, passing the savings to them. The system makes it possible to automatically retrieve coupons and rebates for items in a shopping cart during the activity of an online purchase at an electronic mall or an online merchant site. The system provides coupons to potential customers via email, based on customer profile, geographical information, etc. Manufacturers and merchants can update coupon value and content based on ongoing sales and volume of customer activity.

### SUMMARY OF THE INVENTION

In accordance with the present invention, there is provided a direct, online marketing system and a method for utilizing same. A database stores information usable by a merchant, the database having at least one type of information selected from a group consisting of: personal, demographic, and geographical information relating to present and potential members of goods and services provided by the merchant. Redeemable gifts are sent directly to the present and potential customers at predetermined times dependent upon the information stored in the database.

It is therefore an object of the invention to provide a system of direct, online marketing for merchants to reach present and potential customers.

It is a further object of the present invention to provide a system for automatically inviting customers to redeem one-time “gifts”—discounts, offers, or incentives—on predetermined dates, such as birthdays, anniversaries, holidays, etc. Unlike conventional coupons, which can be shared and/or used again and again, it is another object of the present invention to provide one-time gifts, thus allowing businesses (merchants) to present stronger offers.

It is another object of the present invention to provide a system that provides a unique, trackable code for each discount or offer that can be redeemed by a customer.

It is a further object of the present invention to provide a system that allows merchants to target present or potential customers based on demographic or personal information relating thereto.

These and other objects and advantages of the present invention are more readily apparent with reference to the following detailed description and the accompanying drawings.

### BRIEF DESCRIPTION OF THE DRAWINGS

A complete understanding of the present invention may be obtained by reference to the accompanying drawings, when considered in conjunction with the subsequent detailed description, in which:

FIG. 1 is a block diagram illustrating system operations in accordance with the present invention;

FIG. 2 is a flow chart of activities between a member and a merchant;

FIG. 3 is a flow chart of operations performed by a merchant;

FIGS. 4-10 depict sample screen shots of displays a merchant encounters while setting up the marketing system for a merchant establishment;

FIGS. 11-14 depict sample screen shots of displays that include statistics of the marketing system for use by a merchant;

FIG. 15 is a flow chart of operations performed by a member; and

FIGS. 16-44 depict sample, self-explanatory screen shots of displays for members and merchants for use with the marketing system.

Like reference numerals refer to like parts, components, or individuals throughout the several views of the drawings.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

For purposes of description herein, the word, “member” is used to designate consumers and “merchants” designates advertisers, most often retail establishments that provide products and/or services to the public. The word, “gift” is used herein to describe discounts, offers or incentives.

A direct, online marketing system and a method for utilizing same are provided. A database stores information usable by a merchant and redeemable gifts are sent directly to the present and potential customers at predetermined times dependent upon the information stored in the database.

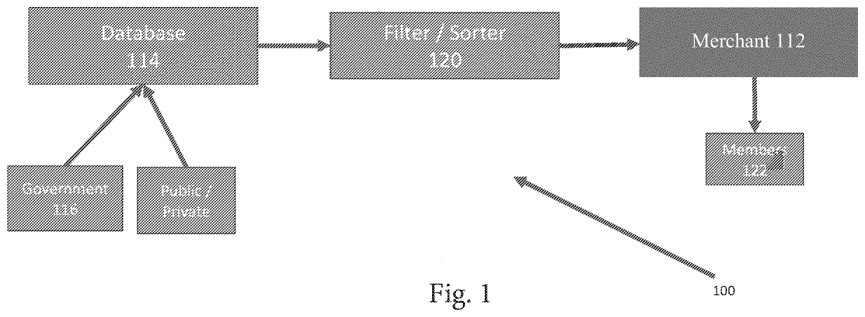

Referring now to FIG. 1, there is shown a block diagram 100 illustrating system operations in accordance with the present invention. The inventive progressive web application is a mobile friendly website that can be accessed through a PC, tablet, or mobile device. A merchant 112, such as a retail establishment (e.g., a restaurant, a department store, a jewelry store, a car dealership, etc.), which provides products and/or services, has the ability to direct redeemable gifts to individual members 122 whose personal, demographic, and geographical information is stored in a database 114.

The information stored in database 114 can be derived by government or quasi-government sources 116, public or private databases 118, or the like.

Operatively connected to database 114 is a mechanism 120 for sorting or filtering the information usable by merchant 112 at any given time. For example, sorting/filtering mechanism 120 can filter database 114 to provide mailing or email addresses for all members living in a certain zip code whose estimated family income is greater than a predetermined amount. The specific email addresses of members 122 are not normally available to merchant 112.

Operatively connected to merchant 112 and accessible thereby is a plurality of members 122 for whom gifts can be provided when they meet criteria set by merchant 112. For example, if the owner of a pizza take-out restaurant wishes to send a gift (e.g., a $2.00 discount) to all member families within a zip code that have purchased a pizza more than two months ago, database 114 and filter/sorter mechanism 120 can be used to identify such members and provide email addresses therefor. Artificial intelligence can also be used in conjunction with database 114 to predictively market to members 122, as is well known in the art.

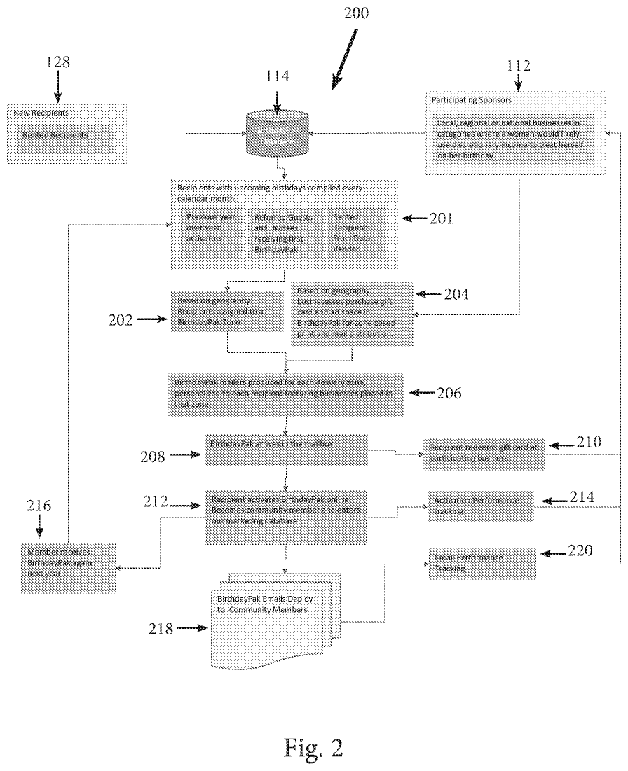

Referring now also to FIG. 2, there is shown a flow chart 200 of activities between members 122 and merchants 112. As described hereinabove with respect to FIG. 1, database 114 has stored information regarding merchants 112 and members 122. Information regarding new members 112′ can be stored in database 114 as they register with the inventive system. Database 114, itself, is dynamic and updatable. The system builds an ever-increasing database of all activity, so with the use of artificial intelligence (e.g., Susan likes Sunday brunch or redeems for pizza on Wednesdays), the system can be tuned.

As a subset of the inventive marketing system, and in accordance with a BirthdayPak®, described in greater detail hereinbelow, members 122 with upcoming birthdays are compiled periodically (e.g., monthly), step 201, from information stored in database 114. It should be understood that merchants 112 can also set up each gift uniquely based on a new redeemer, prior redeemer, geographical proximity, male, female, age, millennial, etc. which should include things such as anniversary, Valentine's Day, date night, wedding, etc. Valid dates for gifts is up to each merchant 112, each gift being separately set up. A Valentine's Day gift could be valid, for example, only on February 14th. The longest period for redeeming each gift may last is typically through the end of each calendar month, but gift redemption periods (start and end dates) can be adjustable.

As stated hereinabove, a subset of the inventive marketing system is known as BirthdayPak®. Members 112 can be assigned to a BirthdayPak zone, step 202, based on the members' place of residence or business. The BirthdayPak program is a customized and specialized feature of the marketing system specifically used to invite certain members to participate in a redeemable gift at one or more predetermined times particularly relevant to the members' situation. It should be understood, however, that the process of alerting members as part of the BirthdayPak subsystem can equally be used by the marketing system independent of any member's specific situation.

Merchants 112 can purchase advertising space in BirthdayPak items and gift cards, not shown, step 204, based on criteria including but not limited to geographic location.

BirthdayPak mailers, not shown, are produced for each delivery zone, step 206, and are personalized to each member 122 featuring businesses located in that zone.

When a BirthdayPak item arrives in the mailbox of a member 122, that member 122 can redeem his or her one-time use gift card at the participating merchant 112, step 210.

When a member 122 activates his or her BirthdayPak item online, step 212, the member automatically becomes a community member and the member's information is added to the system marketing database. Performance tracking, step 214, is also activated. The member 122 receives a BirthdayPak item every subsequent year, step 216.

BirthdayPak emails are generated to community members, step 218, which emails are also tracked, step 220.

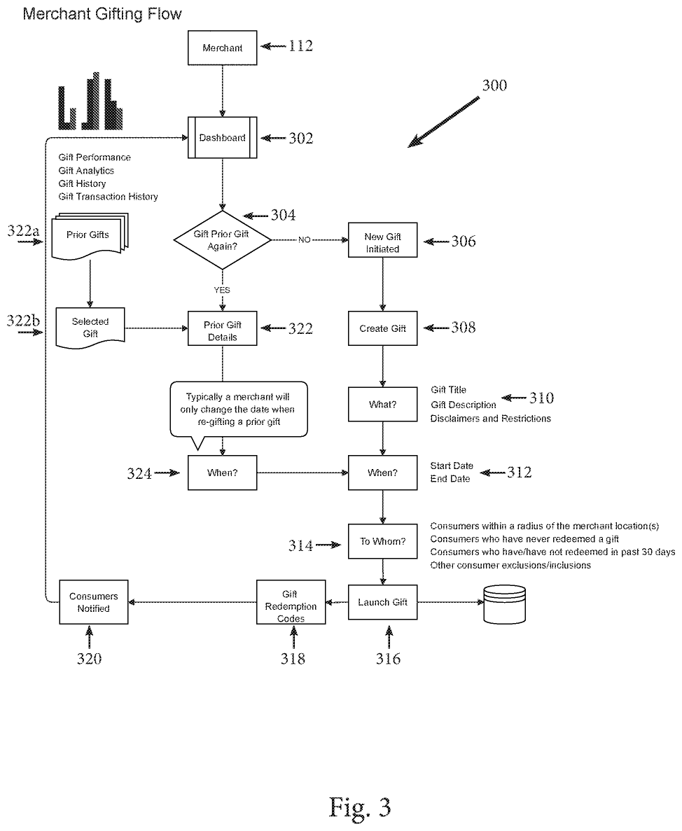

Referring now also to FIG. 3, there is shown a flow chart 300 of operations performed by a merchant 112. A merchant dashboard, described in greater detail hereinbelow, is provided by the system, step 302. The dashboard displays each unique code corresponding to each gift by means of a PC, tablet, or mobile device showing date and time redeemed as well as zip code.

In the preferred embodiment, merchant dashboard reports to all merchants nine separate data points, sortable by any date range, including:
a) new redeemers;
b) calls driven;
c) social network (e.g., Facebook) review actions;
d) website actions;
e) directions to merchant's place of business;
f) gifts redeemed;
g) gifts viewed;
h) gift ratings; and
i) favorites.

If no gift has been previously sent to member 122, step 304, a new gift is initiated, step 306, which includes the steps of:
a) creating a suitable, one-time use gift, step 308;
b) assigning a gift title, describing the gift, and providing disclaimers and restrictions, step 310;
c) calculating a start and end date for redeeming the gift, step 312; and
d) specifying criteria such as: identifying members 122 within a predetermined radius of the location of merchant 112, identifying members 122 who have never redeemed a gift, identifying members who have not redeemed a gift in the past predetermined amount of time, or identifying members 122 who are included or excluded for any of a number of other reasons, step 314.

Once all of the factors and actions have been considered and performed as part of the gift initiation, step 306, the gift is launched, step 316, gift redemption codes are assigned, step 318, and the identified members 122 are notified by mail or email, step 320. Merchants 112 can see the codes that are redeemed by members 122, which, presumably, are entered in the POS of merchant 112. When a POS report is generated and any code appears more than once, that indicates an incident of fraud, as codes are used only once per gift. Each redemption is also time stamped by date/time and zip code.

If a gift has been previously sent to member 122, step 304, the details of such gift are identified, step 322. Such details include but are not limited to prior gift performance, gift analytics, gift history, and gift transaction history, step 322a. The prior gift is then selected, step 322b. If a pizza restaurant decides to repeat the same gifts for one month as were run in the previous month, merchant 112 can accomplish this task with only a few clicks on its digital device.

Merchant 112 is apprised of the gift details, including the date of such gift redemption, step 324, the start and end dates of the previous gift, step 312, and the specifying criteria listed in step 314.

Once again, when all of the factors and actions have been considered and performed as part of the present gift operation, steps 322-314, the gift is launched, step 316, gift redemption codes are assigned, step 318, and the identified members 122 are notified by mail or email, step 320. Members 122 can receive weekly email notifications or they can opt out, or select daily or monthly notifications.

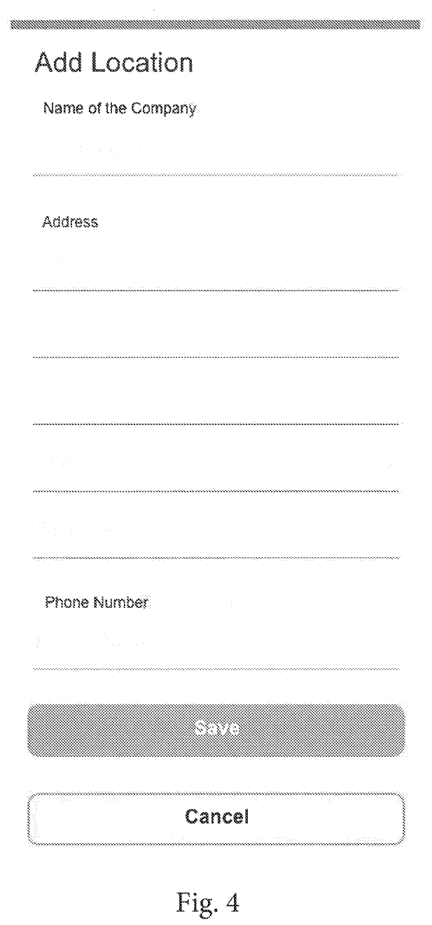

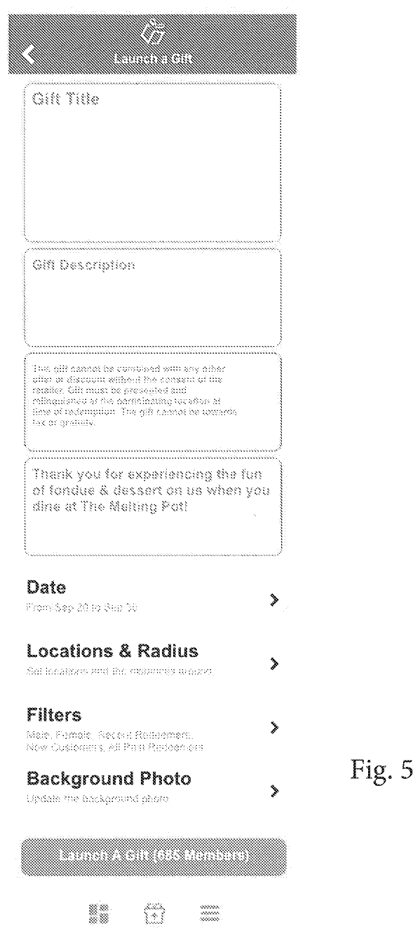

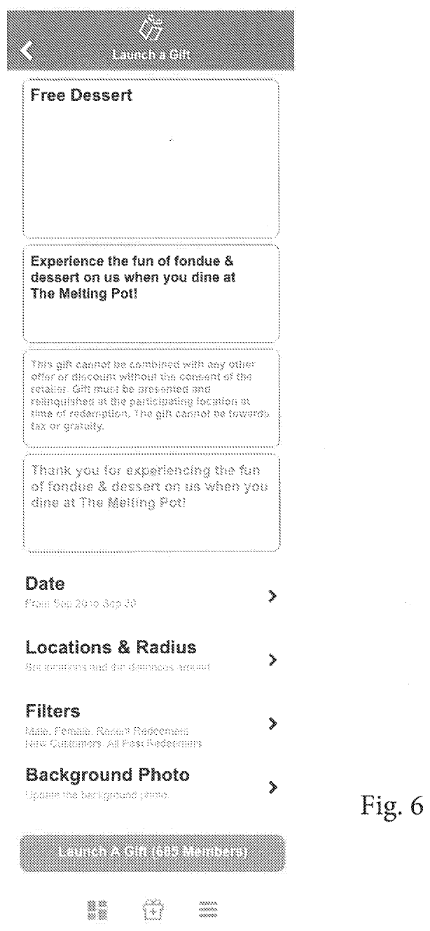

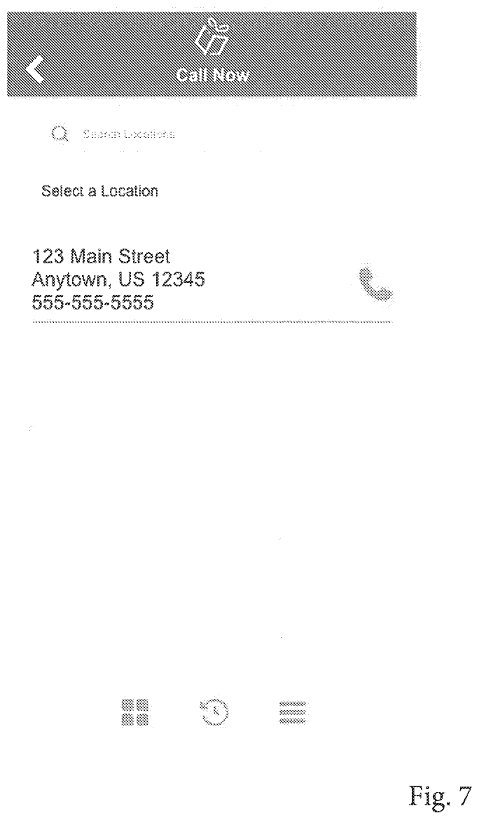

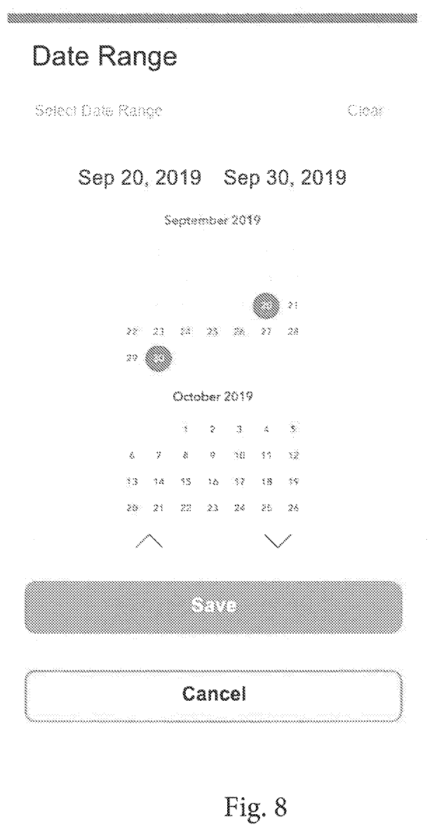

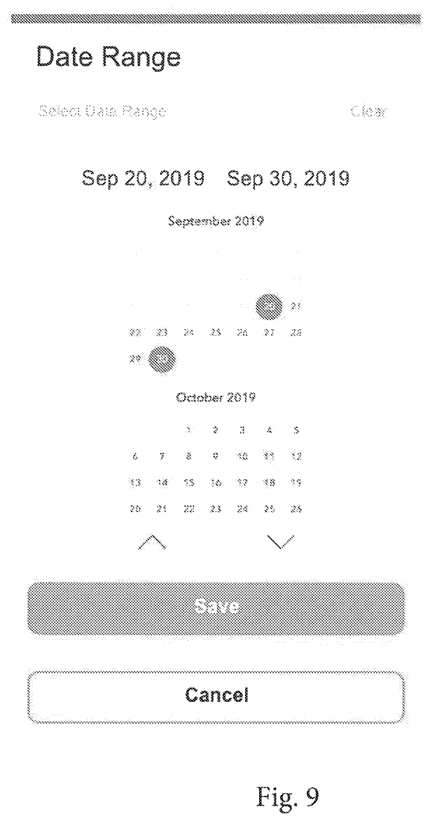

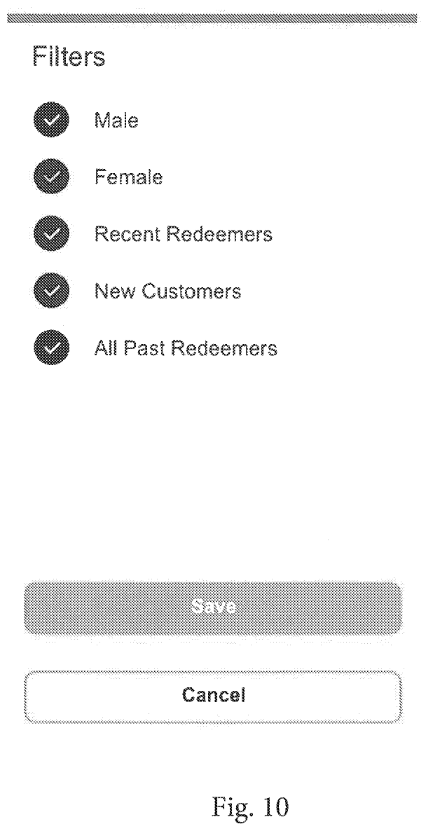

Referring now to FIGS. 4-10, there are shown sample screen shots of displays merchant 112 encounters as he or she sets up the marketing system for the merchant establishment. The information provided by merchant 112 is captured by the system and suitably appended to database 114. In the preferred embodiment, the information requested of merchant 112 and provided thereby includes contact information of the merchant establishment, an a “launch a gift” routine that specifies an identification of a one-time gift to be redeemed, a range of dates during which the gift can be redeemed, a geographical area in which members 122 reside, and filters that define the members 122 for which the gift is to be offered.

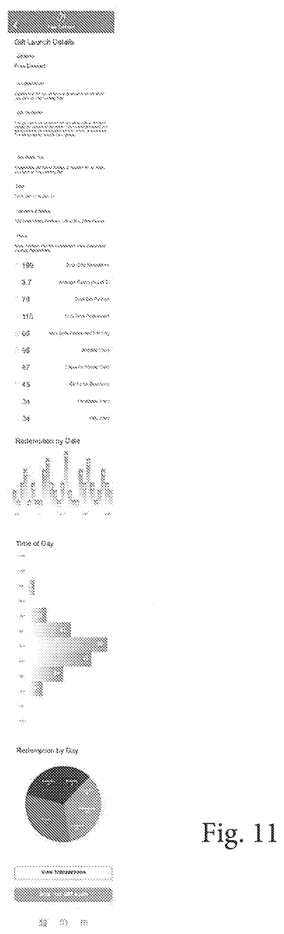

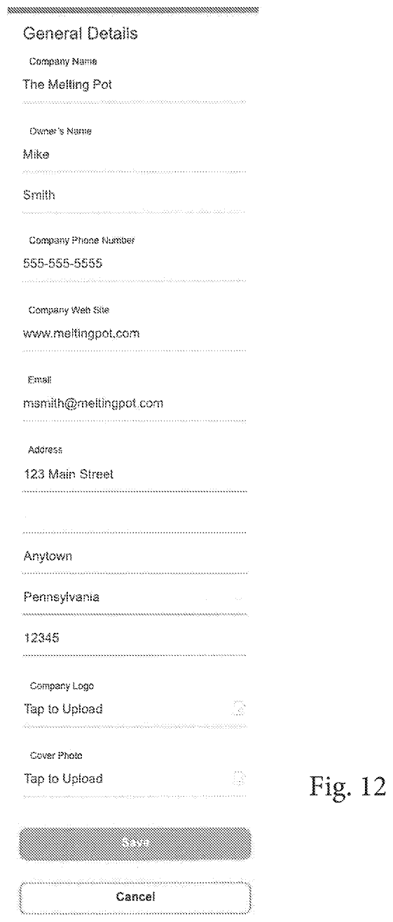

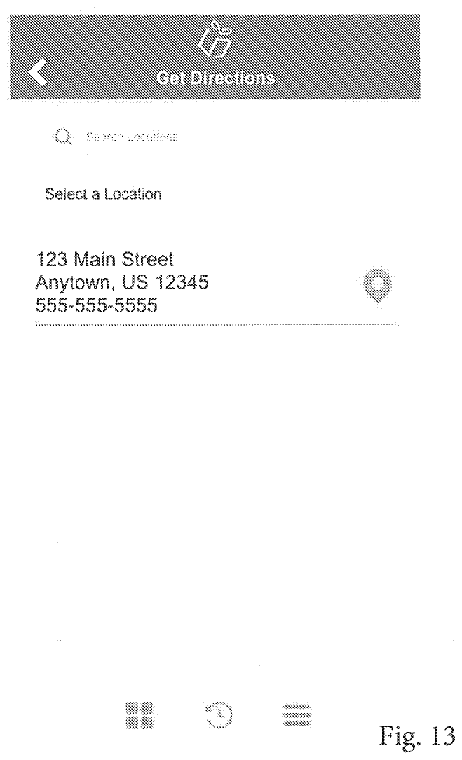

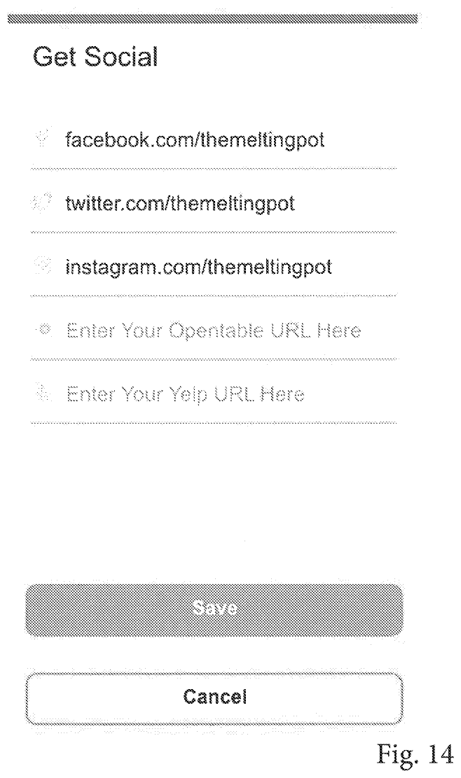

Referring now to FIGS. 11-14, there are shown sample screen shots of displays that include statistics of the marketing system for use by merchant 112.

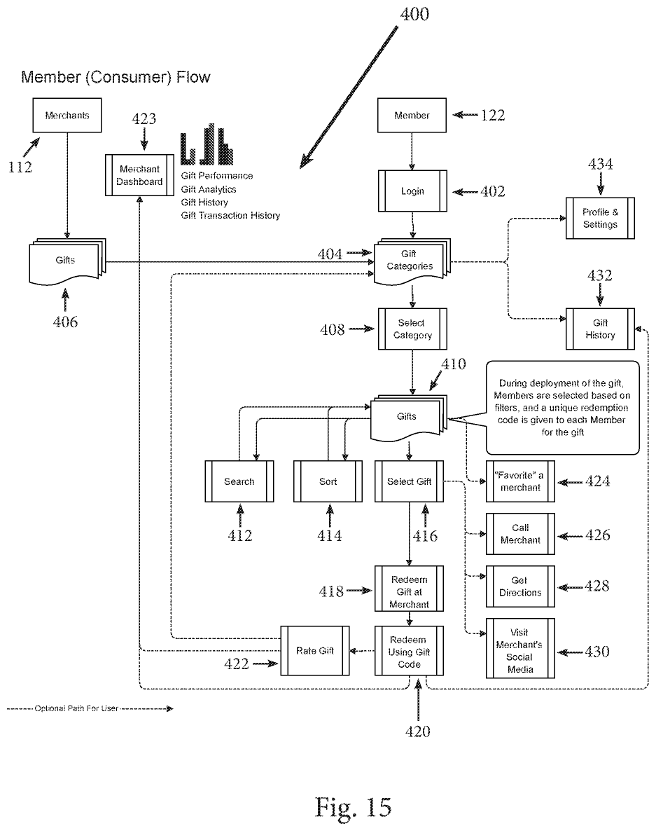

Referring now also to FIG. 15, there is shown a flow chart 400 of operations performed mostly by a member 122 who logs into the system, step 402 and views gift categories, step 404 provided by merchants 112, step 406.

Members 122 register for a free account based on home address, which then connects them with merchants 112 whose place of business is within a selected radius (i.e., 5 miles, or 2-5 miles, selected by merchants 112). Merchant 112 then has a count of people who fall within its selections (e.g., 0-5 miles, females, males, etc.). As an example, a pizza restaurant located at a given location with a Monday night delivery gift may want to limit such a gift to 1 mile and also to offer a Sunday brunch gift limited to 5 miles. Or merchant 112 may wish to bring in new or repeat customers 3-7 miles away.

Member 122 selects a category of one-time use gifts, step 408 and is assigned a unique redemption code, step 410. If a gift category is empty (e.g., no items are listed in “Fashion”), that category is eliminated for that member 122.

Gifts can be searched, step 412, and sorted, step 414, by member 122 prior to selecting his or her gift, step 416.

Member 122 can elect to redeem the gift at the location of merchant 112, step 418, by using the gift code provided by the system, step 420. Member 122 also has the opportunity to rate the gift from 1.0 to 5.0 starts, step 422, which information is sent to the member, step 423.

In the course of selecting a gift, step 410, member 122 can specify his or her favorite merchant, step 424, call the merchant 112, step 426, obtain directions to the location of the merchant 112, step 428, and/or visit the social media of the merchant 112, step 430.

Once the gift is redeemed, step 420, the gift history of member 122 is automatically updated, step 432, as is his or her profile and settings, step 434.

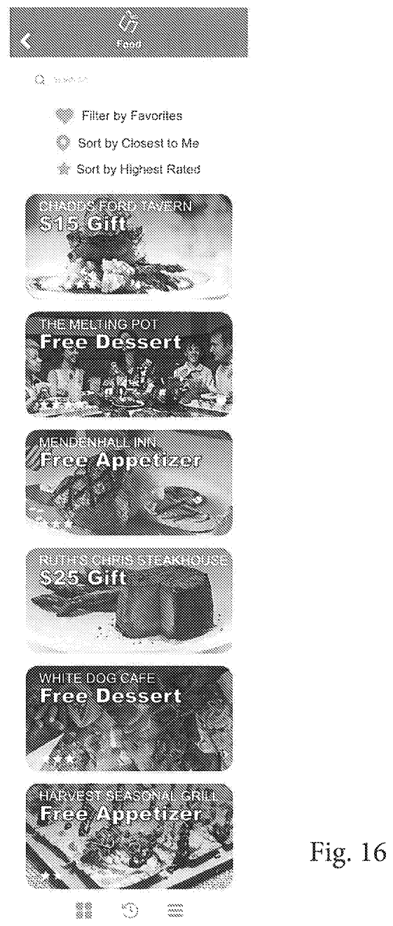

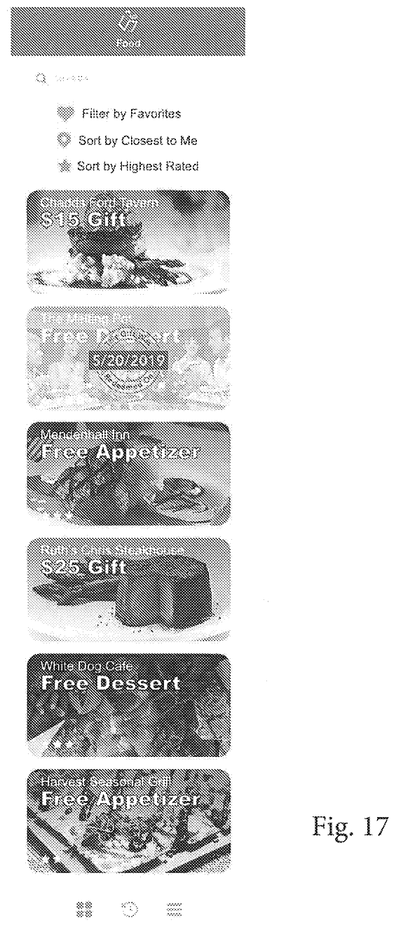

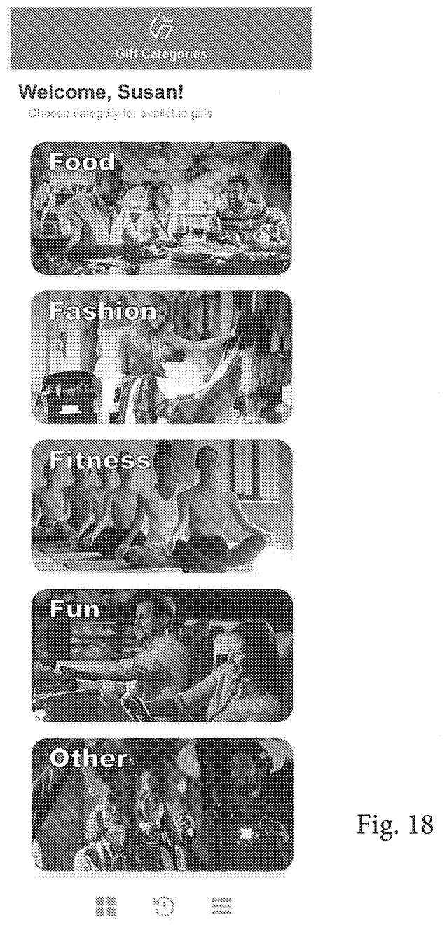

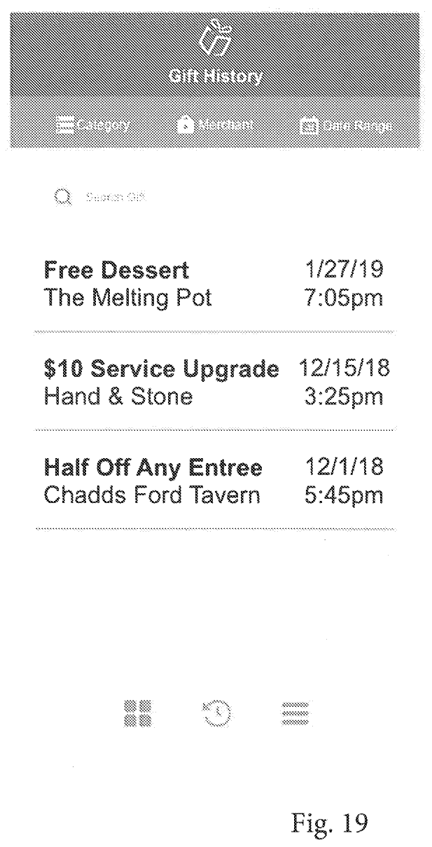

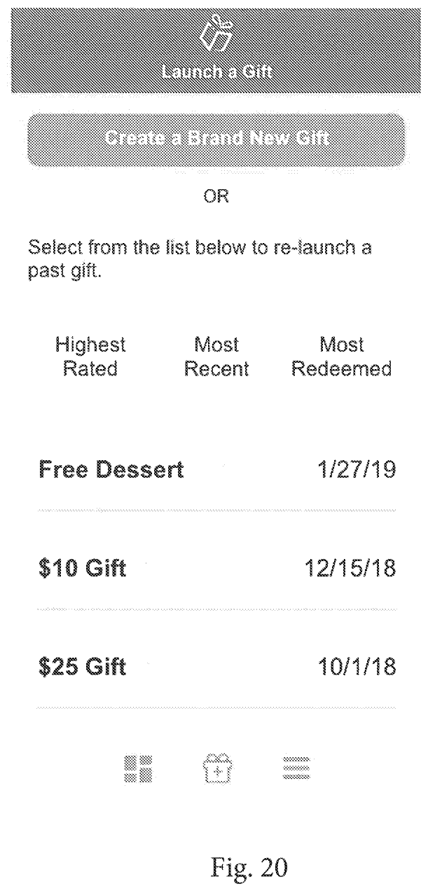

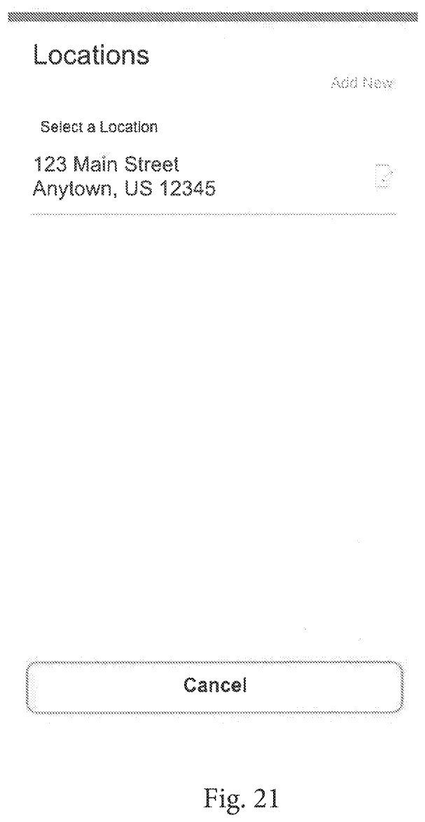

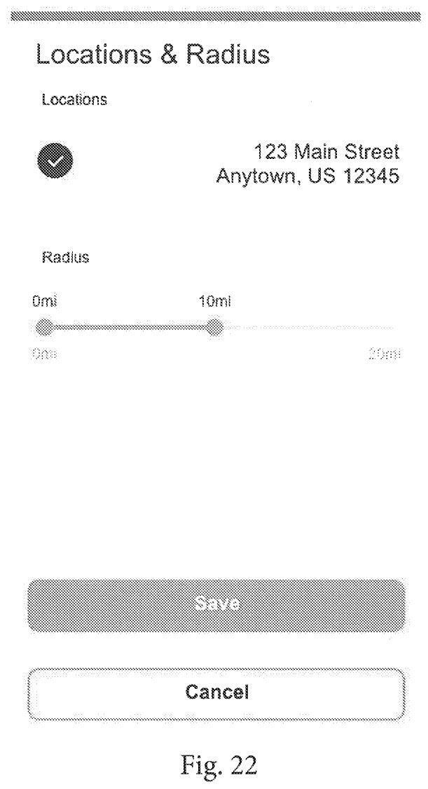

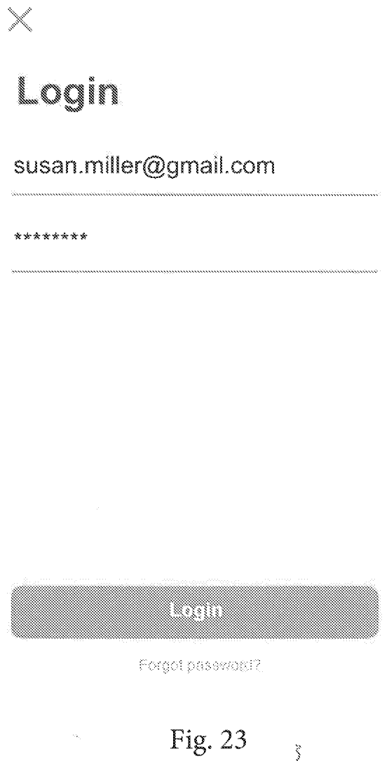

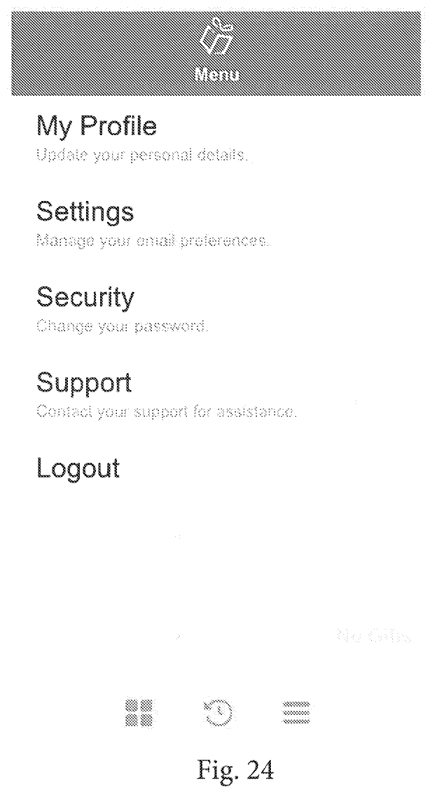

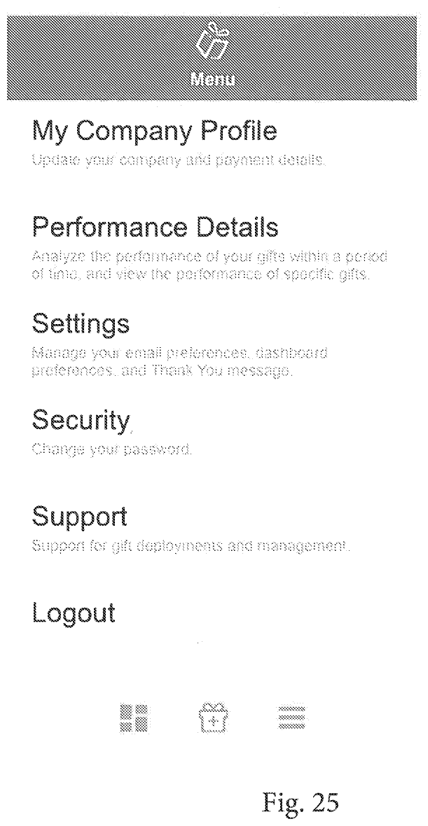

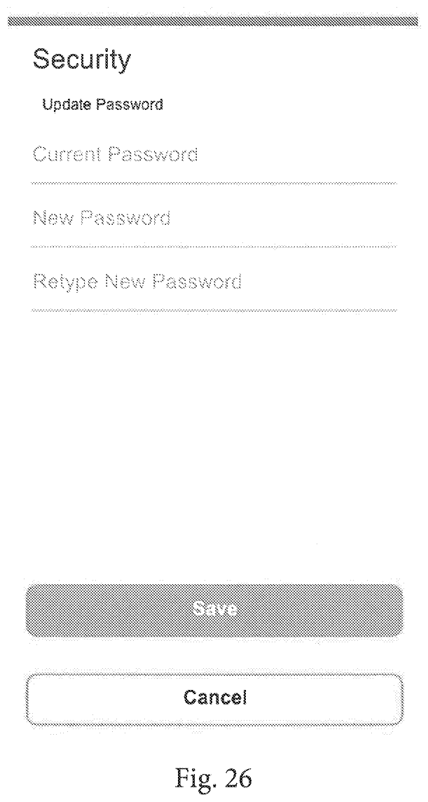

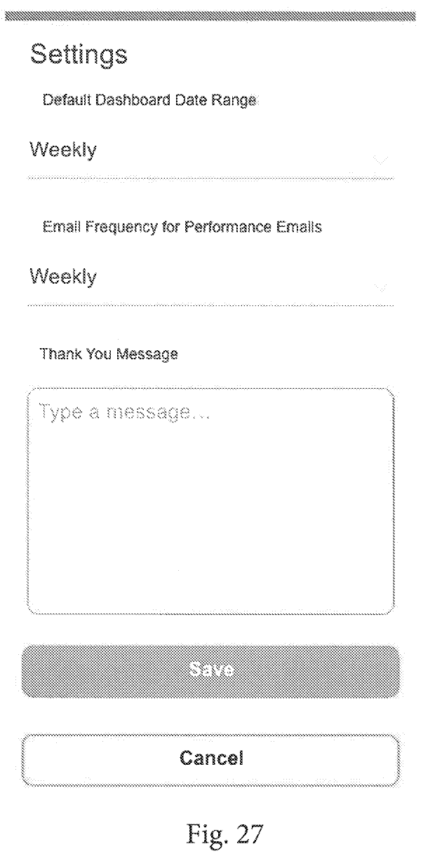

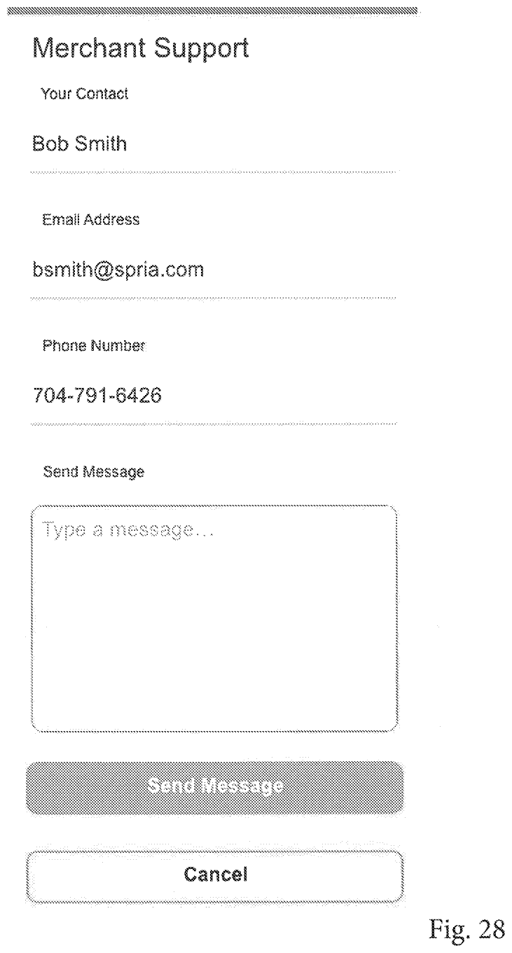

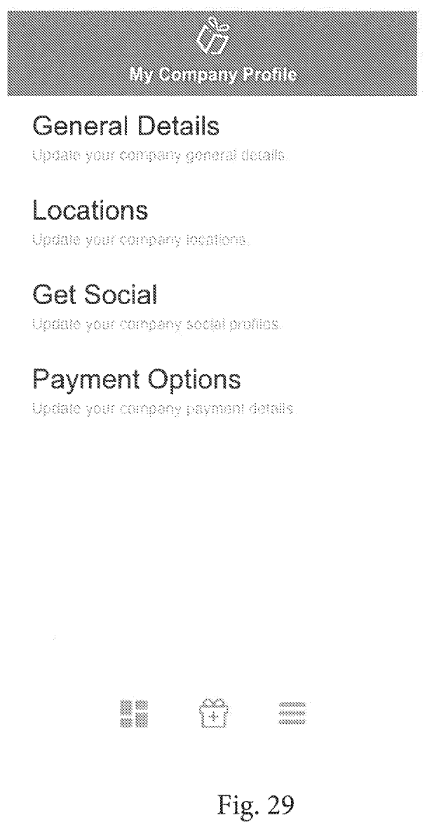

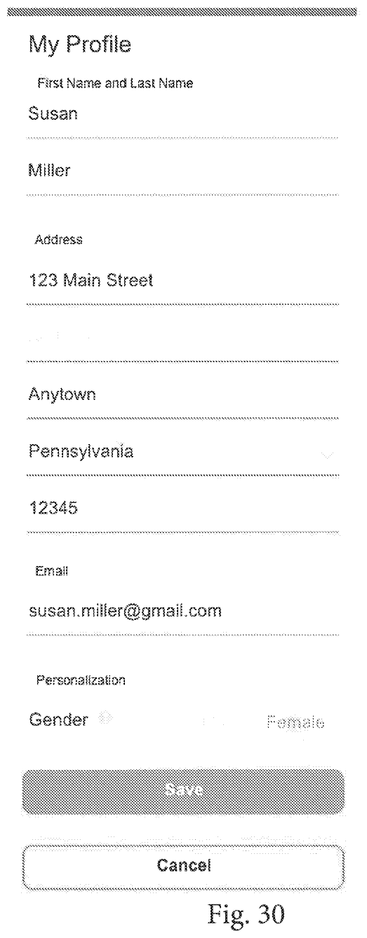

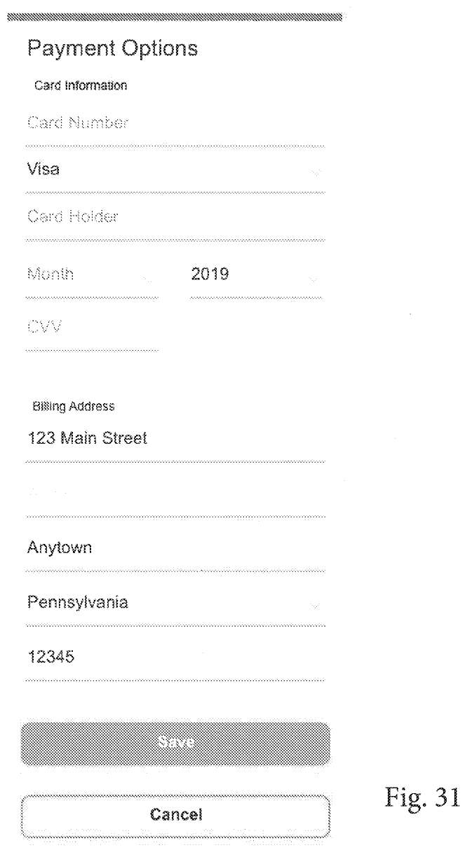

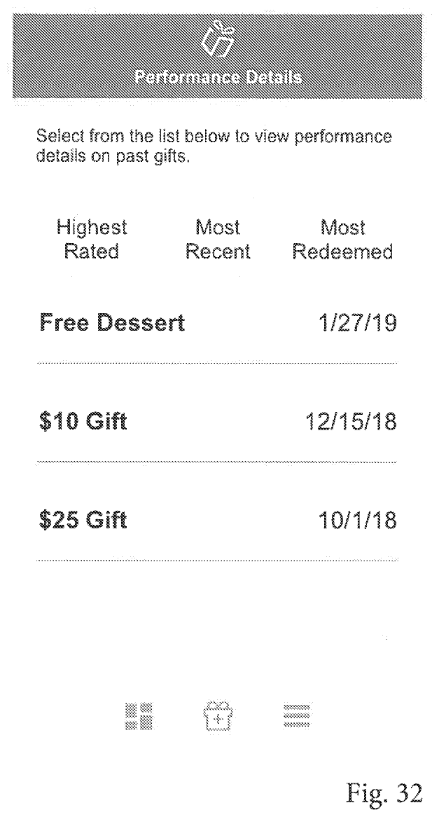

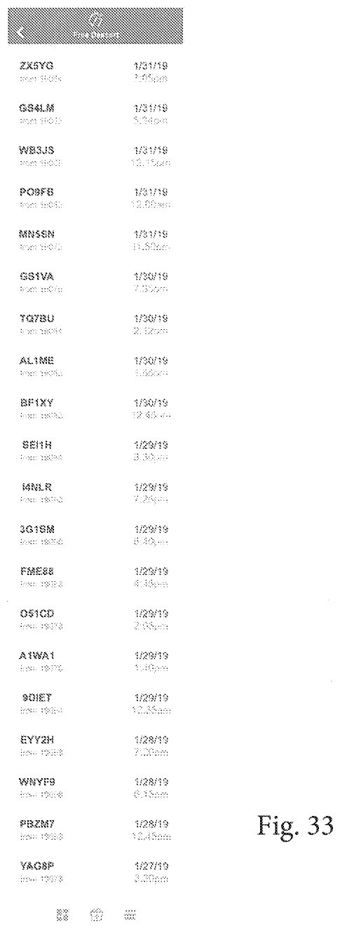

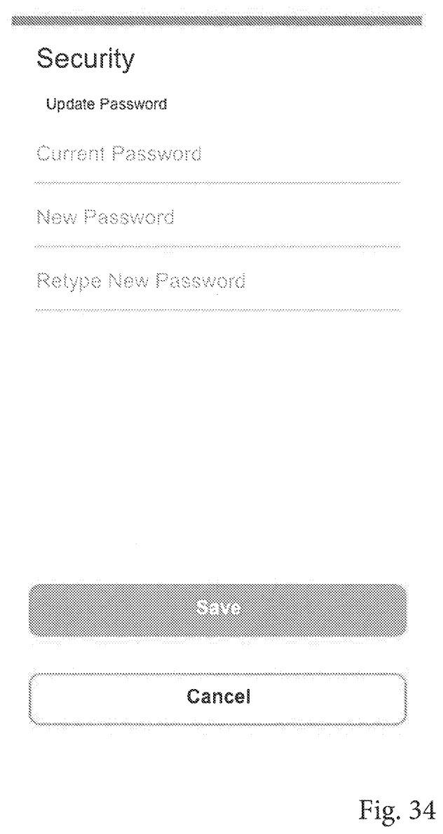

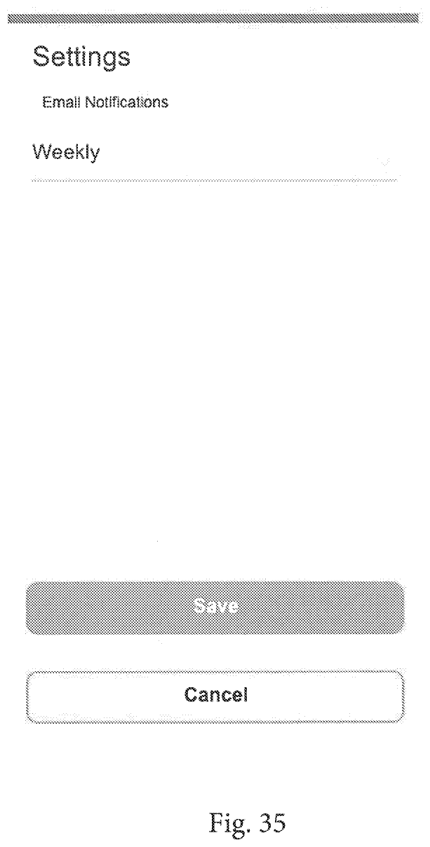

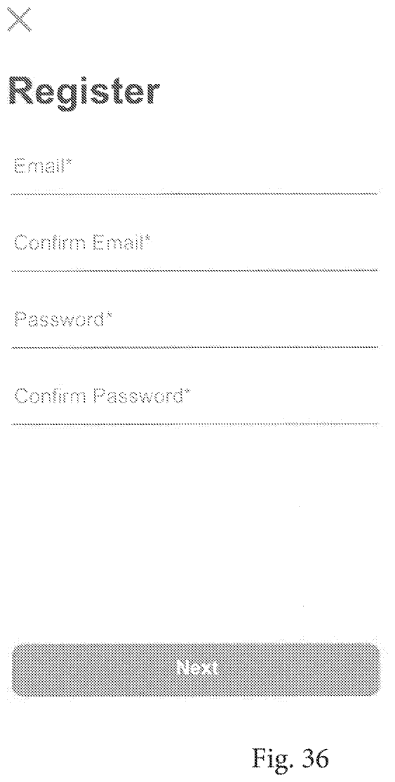

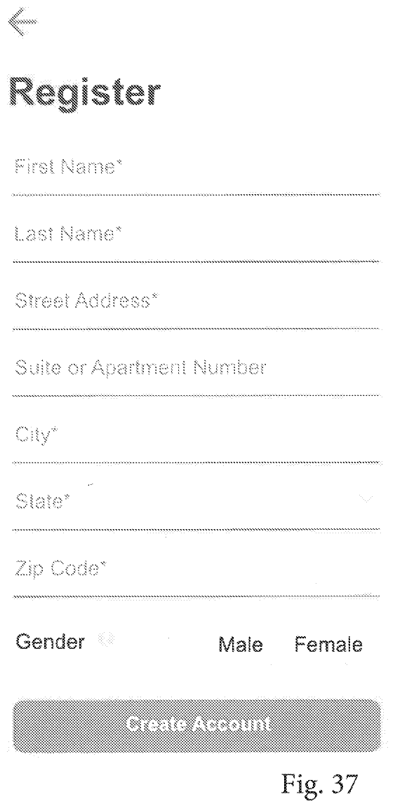

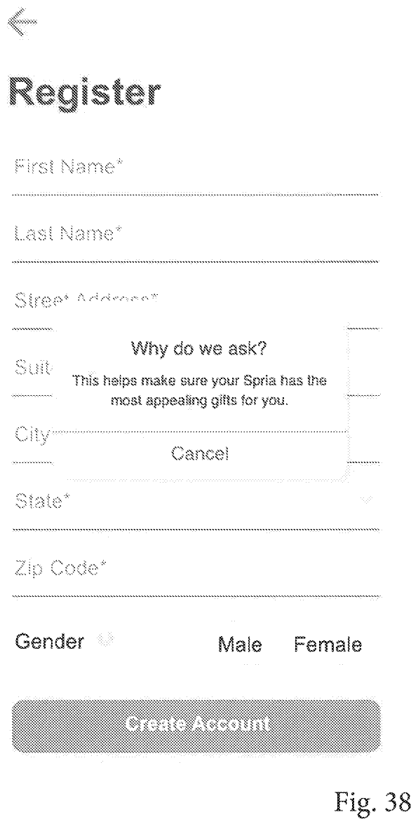

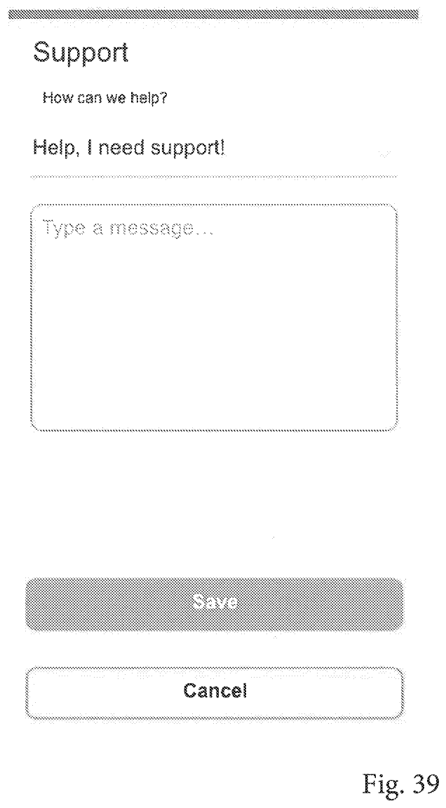

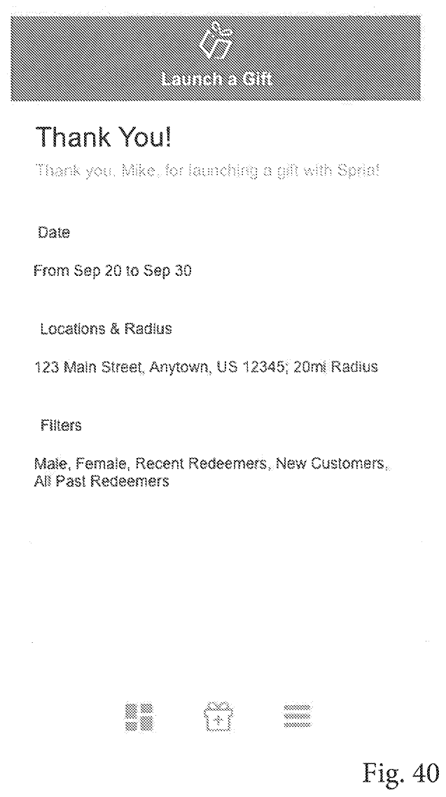

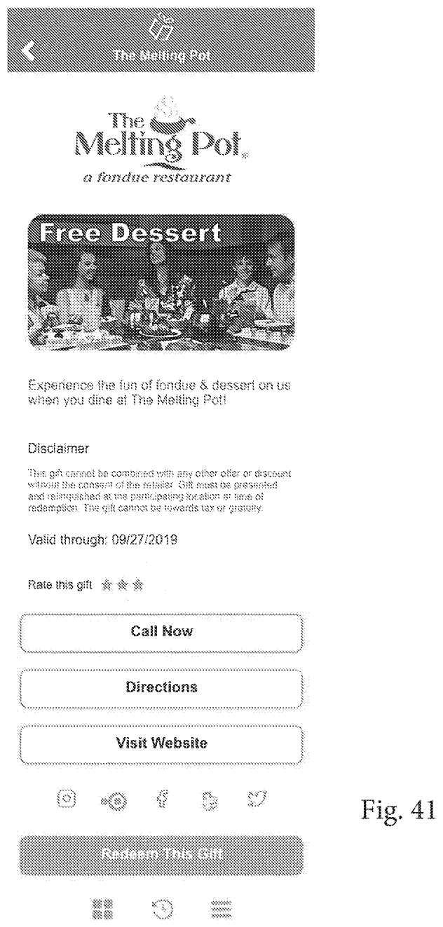

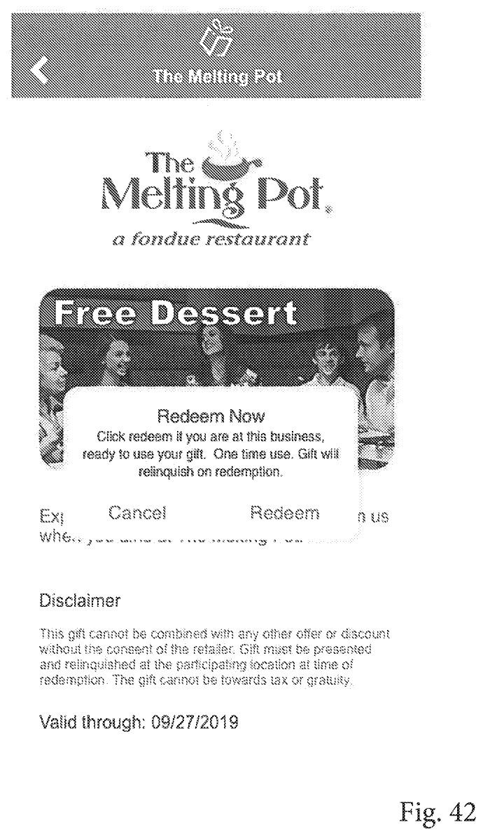

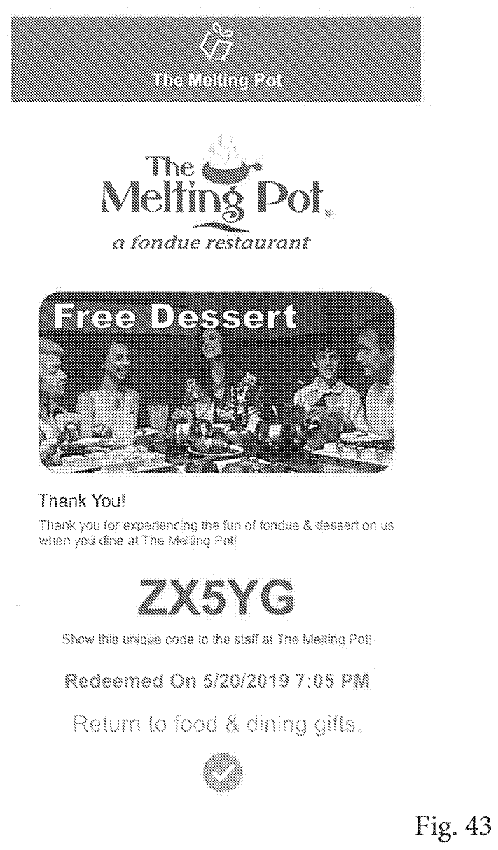

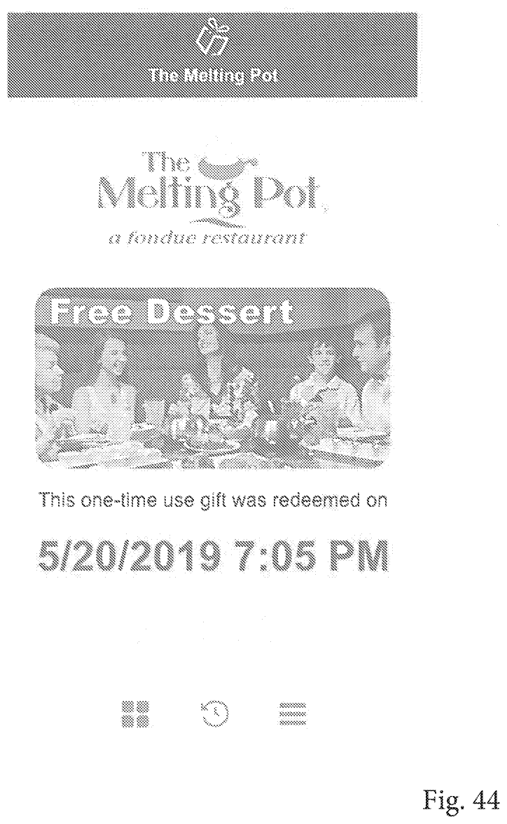

Referring now to FIGS. 16-44, there are shown sample, self-explanatory screen shots of displays for members 112 that include sign-up instructions, gifts of various merchants 122, and the like, as well as statistical information for merchants 122 for use with the marketing system.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a great number of variations of the devices, device components, and method steps set forth in the present description. As will be obvious to one of skill in the art, methods and devices useful for the present methods can include a great number of optional processing elements and steps.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when compositions of matter are claimed, it should be understood that compounds known and available in the art prior to Applicant's invention, including compounds for which an enabling disclosure is provided in the references cited herein, are not intended to be included in any composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element or step not specified in the claim element. As used herein, “consisting essentially of” does not exclude steps that do not materially affect the basic and novel characteristics of the claim. In each instance herein any of the terms “comprising”, “consisting essentially of,” and “consisting of” may be replaced with either of the other two terms. The invention illustratively described herein suitably may be practiced in the absence of any element or elements, limitation or limitations which is not specifically disclosed herein.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

What is claimed is:

1. A method for utilizing a direct, online marketing system, the steps comprising:
a) providing a database comprising information usable by a merchant, the database having at least one type of information selected from a group consisting of: personal, demographic, and geographical information relating to present and potential members of goods and services provided by the merchant; and
b) sending one-time redeemable gifts directly to the present and potential members at predetermined times dependent upon the information stored in the database.

2. The method for utilizing a direct, online marketing system in accordance with claim 1, wherein the redeemable one-time gifts are selected from a group of items consisting of: a one-time discount; a one-time use gift card; and an offer.

3. The method for utilizing a direct, online marketing system in accordance with claim 1, wherein a unique, trackable one-time unique code is assigned to the member for each one-time gift that can be redeemed thereby.

4. The method for utilizing a direct, online marketing system in accordance with claim 1, wherein the members are automatically invited by mail or electronic means to redeem at least one one-time gift on at least one predetermined date.

5. The method for utilizing a direct, online marketing system in accordance with claim 1, wherein the present or potential members are selected based on information residing in the database, the information being selected from at least one category of information from a group of information consisting of: demographic, personal, and geographical information relating thereto.

6. The method for utilizing a direct, online marketing system in accordance with claim 1, wherein the present or potential members are selected based on a predetermined radius of a latitude and longitude location of the merchant, and wherein the predetermined radius is adjustable by the merchant.

7. The method for utilizing a direct, online marketing system in accordance with claim 1, the steps further comprising:
c) providing a sorting/filtering mechanism operatively connected to the database for filtering information therein to provide mailing or email addresses for all members who meet at least one criterion selected from a group of criteria consisting of: estimated family income; size of family; an address of the member; a latitude and longitude location; age of member; gender of member; and other demographic information.

8. The method for utilizing a direct, online marketing system in accordance with claim 1, wherein a one-time gift is sent to all members within at least one predetermined radius of a latitude and longitude location of the merchant who have previously purchased a good or service therefrom within a predetermine time period.

9. The method for utilizing a direct, online marketing system in accordance with claim 1, wherein repeat redeeming members and the predetermined times at which redeemable one-time gifts are sent directly to the present and potential members are selected from a group of dates consisting of: an anniversary; a holiday; other special events; and a date night.

10. The method for utilizing a direct, online marketing system in accordance with claim 1, wherein the merchant can determine valid dates for redeeming each one-time gift.

11. The method for utilizing a direct, online marketing system in accordance with claim 1, the steps further comprising:
c) providing a merchant dashboard for reporting to the merchant, sortable by a predetermined date range, at least one data point selected from a group of data points consisting of: new redeemers; calls driven; social network review actions; website actions; directions to merchant's place of business; gifts redeemed; one-time gifts viewed; one-time gift ratings; and favorites.

12. The method for utilizing a direct, online marketing system in accordance with claim 13, wherein an actual count of people who fall within a merchant's selection criteria appears in the system.

13. The method for utilizing a direct, online marketing system in accordance with claim 1, wherein one-time gifts can be searched and sorted by members prior to selecting a one-time gift.

14. The method for utilizing a direct, online marketing system in accordance with claim 1, wherein use of the database is enhanced by artificial intelligence techniques to facilitate predictively marketing to present and potential members.

15. A direct, online marketing system, comprising:
a) a database comprising information usable by a merchant, the database having at least one type of information selected from a group consisting of: personal, demographic, and geographical information relating to present and potential members of goods and services provided by the merchant; and
b) means for sending redeemable one-time gifts directly to the present and potential members at predetermined times dependent upon the information stored in the database.

16. The direct, online marketing system in accordance with claim 15, further comprising:
c) a sorting/filtering mechanism operatively connected to the database for filtering information therein to provide mailing or electronic addresses for all members who meet at least one criterion selected from a group of criteria consisting of: estimated family income; size of family; an address of the member; latitude and longitude location; age of member; gender of member; preferred date night; wedding anniversary; pet ownership; pet birthdays; and other demographic information.

17. The direct, online marketing system in accordance with claim 15, further comprising:
c) a merchant dashboard for reporting to the merchant, sortable by a predetermined date range, at least one data point selected from a group of data points consisting of: new redeemers; calls driven; social network review actions; website actions; directions to merchant's place of business; one-time gifts redeemed; one-time gifts viewed; one-time gift ratings; and favorites.

18. The direct, online marketing system in accordance with claim 17, wherein the merchant dashboard displays statistical information regarding at least one member's one-time gift redeeming history and zero if no gifts have been redeemed thereby.

19. The direct, online marketing system in accordance with claim 17, wherein an actual count of people who fall within a merchant's selection criteria is displayed on the merchant dashboard prior to launching of the gifts by the merchant.

20. The method for utilizing a direct, online marketing system in accordance with claim 16, wherein the present and potential members reside within a predetermined geographical radius of a location of the merchant, the geographical radius being adjustable by the merchant.
